(19) United States
(12) Patent Application Publication
(10) Pub. No.: US 2026/0030565 A1
(43) Pub. Date: Jan. 29, 2026

(54) SYSTEMS AND METHODS FOR EXTRACTING DATA FROM DOCUMENTS ASSOCIATED WITH ASSETS IN A FACILITY

(71) Applicant: Honeywell International Inc., Charlotte, NC (US)

(72) Inventors: Viraj Srivastava, Bengaluru (IN); Amrutha Kalibhat, Bengaluru (IN); Chinmaya Kar, Al Jubail (SA); Prosenjit Biswas, Dubai (AE)

(21) Appl. No.: 18/783,429

(22) Filed: Jul. 25, 2024

(51) Int. Cl. G06Q 10/0631

(52) U.S. Cl. CPC G06Q 10/0631

(57) ABSTRACT

Various embodiments described herein relate to systems and methods for extracting data from documents associated with assets in a facility. In this regard, the documents are retrieved from data sources initially. Then, a document is processed using a first processing technique to extract first data from the document. This first data corresponds to instrument tags associated with corresponding assets. The first data is validated using certain validation techniques. The document is also processed using a second processing technique to extract second data from the document such that the second data is different from the first data. The validated first data and the extracted second data are then consolidated to configure data templates associated with related assets in the facility. The data templates are also rendered on a display as well.

### TECHNICAL FIELD

The present disclosure generally relates to an asset management system. More particularly, the present disclosure relates to extracting relevant data from documents associated with assets in a facility.

### BACKGROUND

Generally, a facility (such as a building, a factory, an industrial plant, a manufacturing unit, and/or the like) includes numerous assets or equipment such as boilers, chillers, air handling units (AHUs), gas compressors, pumps, and/or the like. Often, these assets are connected to each other directly or indirectly to facilitate numerous operations in the facility. For instance, the assets may be arranged in a hierarchical manner where some of the assets have upstream/downstream relationships with other assets. At times, when there is fault or anomaly observed in one asset, it may fail to function normally. Additionally, the fault may affect other assets too due to the upstream/downstream relationships thereby impacting overall operations in the facility. The facility often employs domain experts or subject matter experts such as engineers to model assets, perform root cause analysis for analyzing faults/anomalies, to analyze alarms, etc. Such experts often manually analyze engineering diagrams such as Process Flow Diagrams (PFDs) and/or Piping & Instrumentation Diagrams (P&IDs) to understand the upstream/downstream relationships, to model assets, to perform root cause analysis, to analyze alarms, etc. However, this has associated challenges too. Firstly, the diagrams are often complex as it involves several representations, connections, notes, and/or the like associated with numerous assets in the facility. Manual analysis of such complex diagrams is commonly prone to errors and a cumbersome task. Secondly, all of the engineering diagrams may not have standard conventions due to which the experts may not understand certain assets and their relationships. Due to this, for instance, the fault and/or an alarm may not be rightly analyzed in a timely manner causing the fault to flow up/down to other related assets in the facility. This may also lead to downtime/shutdowns in the facility as well. With this, analysis of the engineering diagrams becomes a challenging task which eventually impacts the operations in the facility as well.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic diagram showing an exemplary environment comprising multiple facilities, in accordance with one or more example embodiments described herein.

FIG. 2 illustrates a schematic diagram showing an implementation of a controller that may execute techniques in accordance with one or more example embodiments described herein.

FIG. 3 illustrates a schematic diagram showing an implementation of an exemplary data extracting system, in accordance with one or more example embodiments described herein.

FIG. 4 illustrates a schematic diagram showing an exemplary block diagram associated with one or more operations of exemplary data extracting system, in accordance with one or more example embodiments described herein.

FIG. 5 illustrates a schematic diagram showing an exemplary graphical representation of instrument tags, in accordance with one or more example embodiments described herein.

FIG. 6 illustrates a schematic diagram showing an exemplary hierarchical representation of extracted text, in accordance with one or more example embodiments described herein.

FIG. 7 illustrates a schematic diagram showing an exemplary representation of a data template, in accordance with one or more example embodiments described herein.

FIG. 8 illustrates a flowchart showing a method described in accordance with one or more example embodiments described herein.

FIG. 9 illustrates a flowchart showing a method described in accordance with one or more example embodiments described herein.

FIG. 10 illustrates a flowchart showing a method described in accordance with one or more example embodiments described herein.

FIG. 11 illustrates a flowchart showing a method described in accordance with one or more example embodiments described herein.

FIG. 12 illustrates a flowchart showing a method described in accordance with one or more example embodiments described herein.

FIG. 13 illustrates a flowchart showing a method described in accordance with one or more example embodiments described herein.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with one or more example embodiments of the current disclosure, a method for extracting data from one or more documents associated with one or more assets in a facility is described herein. In this regard, the method comprises retrieving the one or more documents associated with the one or more assets from one or more data sources. Then, the method comprises processing at least one document of the one or more documents using a first processing technique of one or more processing techniques. Further, the method comprises extracting first data from the at least one document based on the first processing technique. In this regard, the first data comprises one or more instrument tags associated with corresponding assets. Furthermore, the method comprises validating the first data using one or more validation techniques. Also, the method comprises processing the at least one document of the one or more documents using a second processing technique of the one or more processing techniques. The method further comprises extracting second data from the at least one document based on the second processing technique such that the second data is different from the first data. The method also comprises configuring one or more data templates based on consolidation of the validated first data and the extracted second data. Additionally, the method comprises rendering, on a display, the one or more data templates for the corresponding assets.

In accordance with another embodiment of the current disclosure, a system for extracting data from one or more documents associated with one or more assets in a facility is described herein. The system comprises a processor and a memory communicatively coupled to the processor, wherein the memory comprises one or more instructions which when executed by the processor, cause the processor to retrieve the one or more documents associated with the one or more assets from one or more data sources. The processor is then configured to process at least one document of the one or more documents using a first processing technique of one or more processing techniques. Further, the processor is configured to extract first data from the at least one document based on the first processing technique. In this regard, the first data comprises one or more instrument tags associated with corresponding assets. Furthermore, the processor is configured to validate the first data using one or more validation techniques. Also, the processor is configured to process the at least one document of the one or more documents using a second processing technique of the one or more processing techniques. Then, the processor is configured to extract second data from the at least one document based on the second processing technique such that the second data is different from the first data. The processor is also configured to configure one or more data templates based on consolidation of the validated first data and the extracted second data. Additionally, the processor is configured to render, on a display, the one or more data templates for the corresponding assets.

In accordance with yet another embodiment of the current disclosure, a non-transitory, computer-readable storage medium having instructions stored thereon and executable by one or more processors is described herein. In this regard, the instructions when executed by one or more processors cause the one or more processors to retrieve the one or more documents associated with the one or more assets from one or more data sources. The one or more processors are then configured to process at least one document of the one or more documents using a first processing technique of one or more processing techniques. Further, the one or more processors are configured to extract first data from the at least one document based on the first processing technique. In this regard, the first data comprises one or more instrument tags associated with corresponding assets. Furthermore, the one or more processors are configured to validate the first data using one or more validation techniques. Also, the one or more processors are configured to process the at least one document of the one or more documents using a second processing technique of the one or more processing techniques. Then, the one or more processors are configured to extract second data from the at least one document based on the second processing technique such that the second data is different from the first data. The one or more processors are also configured to configure one or more data templates based on consolidation of the validated first data and the extracted second data. Additionally, the one or more processors are configured to render, on a display, the one or more data templates for the corresponding assets.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### DETAILED DESCRIPTION OF THE DRAWINGS

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase can be included in at least one example embodiment of the present disclosure, and can be included in more than one example embodiment of the present disclosure (importantly, such phrases do not necessarily refer to the same example embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some example embodiments, or it can be excluded.

In recent times, technologies based on Artificial Intelligence (AI) and/or Machine Learning (ML) are often preferred for overall management of the facility. In this regard, AI and/or ML based closed-loop autonomous systems are used over traditional rule-based systems in the facility. Data driven digital twins associated with assets, corresponding sub-assets, processes become a critical requirement for such closed-loop systems to be enabled. That is, the digital twins should have all required information associated with assets and processes in the facility. Traditionally, the facility relies on domain experts or subject matter experts such as engineers to configure the digital twins with all required information associated with assets and processes. In this regard, the experts may be required to manually configure hundreds and thousands of digital twins where they manually provide process measurements, parameters, control commands, workflows, relationship between assets, etc., related to assets and processes. This becomes a time-consuming and inefficient task where experts spend valuable time in performing such manual work. Additionally, the experts rely on engineering diagrams to derive information such as process measurements, parameters, control commands, workflows, relationship between assets, etc., to configure the digital twins. That is, they manually analyze Process Flow Diagrams (PFDs) and/or Piping & Instrumentation Diagrams (P&IDs) to derive the required information. Such manual analysis is often erroneous as the engineering diagrams are complex as it involves several representations, connections, notes, and/or the like associated with numerous assets and processes in the facility. This complexity may lead the experts to wrongly analyze symbols, connections, terminologies, and/or the like in the diagrams. Also, the experts may be unable to scale up to huge volume of diagrams to accurately analyze and derive required information from the diagrams. With this, the digital twins may be configured erroneously leading to poor management of the facility.

Thus, to address the above challenges, various examples of systems and methods described herein facilitate extraction of data from documents associated with assets in a facility. At times, to efficiently manage and control operations of fleet of the said assets, it becomes essential to have all relevant data associated with the assets. In this regard, personnel such as operators, engineers, and/or the like in the facility are often expected to gather relevant data associated with the assets and tabulate the gathered data. In such scenarios, for instance, the system proposed herein acts as an automated tool to extract, gather, and consolidate the relevant data from the documents such as, for example, engineering documents, Process Flow Diagrams (PFDs), Piping & Instrumentation Diagrams (P&IDs), datasheets, and/or the like associated with the assets. The system described herein is initially configured to retrieve from one or more data sources, one or more documents associated with one or more assets in the facility. The data sources correspond to databases or repositories associated with the facility where the documents are generally stored. The documents may be provided by one or more users associated with the facility and the one or more users may correspond to operators, engineers, customers, original equipment manufacturers (OEMs), and/or other personnel associated with the facility. The documents described herein comprise information in various formats that is, with symbols such as lines, arrows, components, connections, and/or the like along with texts comprising alphabets and/or numbers.

The system utilizes one or more processing techniques to process the one or more documents in order to extract the relevant data. Per this aspect, firstly the system processes at least one document of the one or more documents using a first processing technique. In this regard, the first processing technique corresponds to one or more image processing techniques. The said image processing techniques may be based on machine learning (ML) models and natural language processing (NLP). Using the first processing technique, the system extracts first data from the at least one document. That is, the system utilizes the first processing technique to extract one or more instrument tags associated with corresponding assets from the at least one document. More particularly, the system utilizes the first processing technique to analyze text in proximity to symbolic representation associated with an asset (or components of the asset) in the at least one document. In view of this, the system comprises one or more first thresholds to analyze the text in proximity to the said symbolic representations so that only relevant text is extracted as instrument tags such as process parameters, process measurements, control commands, asset identifiers, and/or the like associated with the corresponding assets. The one or more first thresholds can be defined relative to size of symbolic representations, type of symbolic representations, co-ordinates of text in the at least one document, distance between at least one symbolic representation and text, and/or the like. Further, the extracted one or more instrument tags are validated using one or more validation techniques. A first validation technique can correspond to a comparison between one or more tags provided by one or more users and at least one instrument tag of the one or more extracted instrument tags. The one or more users here may be, but not limited to OEMs, customers, and/or the like. Based on the first validation, the system determines a first validation score for the at least one instrument tag. Then, a second validation technique can correspond to usage of one or more rules along with spatial location of text i.e., co-ordinates of text in the at least one document, and material flow directions in order to validate the at least one instrument tag. The one or more rules may be developed based on domain knowledge of one or more technical experts associated with the facility over a period of time. Based on the second validation, the system determines a second validation score for the at least one instrument tag. Using both of first and second validation scores, the system may determine a validation score for the at least one instrument tag indicative of an accuracy level associated with the at least one instrument tag that is extracted from the at least one document. Secondly, the system utilizes a second processing technique of the one or more processing techniques to process the at least one document. In this regard, the second processing technique corresponds to, for instance, optical character recognition (OCR). In view of this, the system comprises one or more second thresholds to analyze text associated with one or more pre-defined shapes so that only relevant text is extracted as second data associated with corresponding assets. The second data may be, but not limited to asset specifications, operating points, measurements associated with assets, maintenance notes associated with assets, and/or the like. The one or more second thresholds can be defined relative to size of shapes, type of shapes, co-ordinates of text in the at least one document, and/or the like. Also, using the second data, one or more units of measurements associated with corresponding assets along with one or more operating limits are derived.

The validated first data and the extracted second data are then consolidated to configure one or more data templates. In this regard, appropriate fields of the one or more data templates are filled using the consolidated data. The system is also capable of rendering the one or more data templates on a user interface so that personnel in the facility can view and interact with the one or more data templates. The data templates filled using the consolidated data are then used to configure appropriate models or digital twins for corresponding assets. Additionally, the said data templates are also used to diagnose and identify root causes of faults associated with assets as the consolidated data provides upstream and/or downstream relationships between assets along with material flow directions. This facilitates identification of exact location of fault along with affected assets. Also, the said data templates automate analysis and classification of alerts to ensure proper addressing of alerts. With such an approach, accuracy of data extraction from various documents is enhanced so that assets can be modelled as appropriate with minimal efforts, time, and/or resources along with timely addressal of faults and/or alerts using corrective actions. This improves overall management of assets along with efficient usage of human and/or computing resources in the facility.

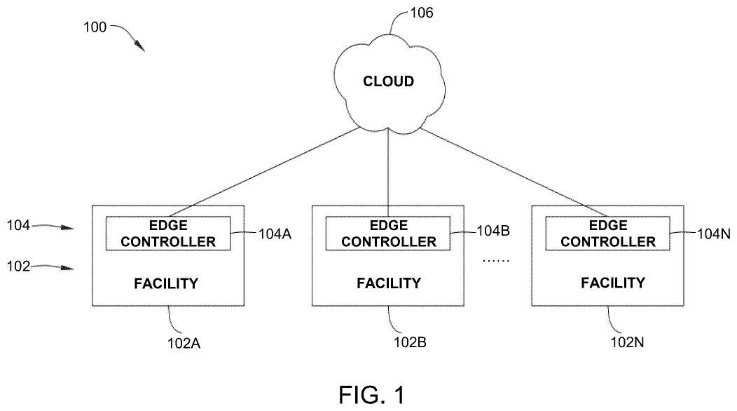

FIG. 1 illustrates a schematic diagram showing an exemplary environment comprising multiple facilities, in accordance with one or more example embodiments described herein. According to various example embodiments described herein, an exemplary environment 100 comprises one or more facilities 102a, 102b . . . 102n (collectively “facilities 102”). In some example embodiments, a facility of the one or more facilities 102a, 102b . . . 102n may correspond to, for example, a building, a factory, an industry, a corporate firm, an industrial plant, a manufacturing facility, and/or the like. In some example embodiments, the one or more facilities 102a, 102b . . . 102n in the illustrative environment 100 may be of same type. In some example embodiments, the one or more facilities 102a, 102b . . . 102n in the illustrative environment 100 may be of different type. As it may be understood, in some example embodiments described herein, a facility of the one or more facilities 102a, 102b . . . 102n often includes several assets to facilitate numerous operations in the facility. At times, these assets are connected to each other directly or indirectly to facilitate the said operations in the facility. For instance, the assets may be arranged in a hierarchical manner with upstream and/or downstream relationships between one another. To efficiently manage such an arrangement of the assets, it becomes essential to have all information/data related to the assets in the facility. In this regard, the facilities 102 described herein make sure to automatically extract data associated with the assets from documents such as Process Flow Diagrams (PFDs), Piping & Instrumentation Diagrams (P&IDs), datasheets, and/or other related documents that have all necessary information related to the assets.

In some example embodiments, a cloud 106 is operably coupled with one or more facilities 102a, 102b . . . 102n, meaning that communication between the cloud 106 and one or more facilities 102a, 102b . . . 102n is enabled. The cloud 106 may represent distributed computing resources, software, platform or infrastructure services which can enable data handling, data processing, data management, and/or analytical operations on the data exchanged & transacted in the facilities 102. In some example embodiments described herein, the cloud 106 represents a platform that comprises one or more services to facilitate asset management and/or overall facility management as well. Per this aspect, the one or more services of the cloud 106 appropriately handle, process, and/or manage the data at the cloud 106. In this regard, the data at the cloud 106 corresponds to one or more documents and/or any relevant data associated with the assets in facilities 102. The documents may be provided by one or more users associated with the facility and the one or more users may correspond to operators, engineers, customers, original equipment manufacturers (OEMs), and/or other personnel associated with the facility. Also, the cloud 106 may include or generate models required to handle, process, and/or manage the data of a respective facility. In some example embodiments, the cloud 106 includes one or more servers that may be programmed to communicate with the one or more facilities 102a, 102b . . . 102n and to exchange data as appropriate. The cloud 106 may be a single computer server or may include a plurality of computer servers. In some example embodiments, the cloud 106 may represent a hierarchal arrangement of two or more computer servers, where perhaps a lower-level computer server (or servers) processes the data, for example, while a higher-level computer server oversees operation of the lower-level computer server or servers.

Each of the facilities 102 may include a variety of operations. In this regard, the assets in each of the facilities 102 may be humongous in number and diverse as well. For instance, a facility may include wide range of assets such as boilers, chillers, air handling units (AHUs), variable air volumes (VAVs), pipes, gas compressors, pumps, sensors, and/or the like to support various operations in the facility. In some example embodiments, the cloud 106 may manage and/or control respective assets in the facilities 102. In this regard, in the example shown in FIG. 1, each of the one or more facilities 102a, 102b . . . 102n includes a respective edge controller (alternatively, edge gateway) 104a, 104b . . . 104n (collectively “edge controllers 104” or “edge gateways 104”). In some example embodiments, each of one or more edge controllers 104a, 104b . . . 104n is configured to receive the data from the respective facilities 102. In this regard, in some example embodiments, the assets may provide the necessary data to a respective edge controller in the respective facility. In some examples, the one or more edge controllers 104a, 104b . . . 104n may operate as intermediary node to transact the data between the facilities 102 and/or the cloud 106. In this regard, the data includes one or more documents associated with the assets in the facilities 102. Additionally, the data also includes metadata and/or other relevant data associated with the assets in the facilities 102. In some examples, each of the one or more edge controllers 104a, 104b . . . 104n is capable of receiving the data from disparate data sources e.g., but not limited to, in different data formats and/or using various data communication protocols, from the facilities 102. In this regard, each of the one or more edge controllers 104a, 104b . . . 104n can receive & filter the data and translate the data into a common language and/or format (e.g. normalized data) for subsequent communication to the cloud 106. The common language and/or format may be compatible with and expected by the cloud 106.

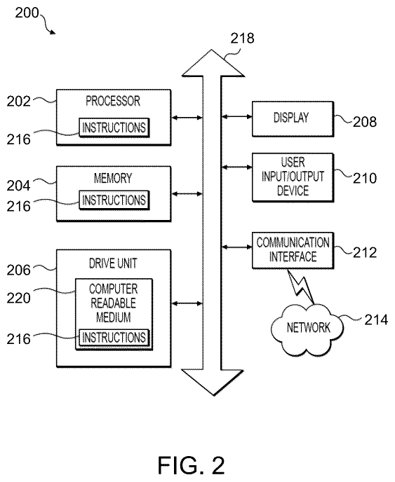

FIG. 2 illustrates a schematic diagram showing an implementation of a controller that may execute techniques in accordance with one or more example embodiments described herein. In one or more example embodiments, controller 200 described herein may include a set of instructions that can be executed to cause the controller 200 to perform any one or more of the methods or computer-based functions disclosed herein. The controller 200 may operate as a standalone device or may be connected, e.g., using a network, to other computer systems or peripheral devices.

In a networked deployment, the controller 200 may operate in the capacity of a server or as a client in a server-client user network environment, or as a peer computer system in a peer-to-peer (or distributed) network environment. The controller 200 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 200 can be implemented using electronic devices that provide voice, video, or data communication. Further, while the controller 200 is illustrated as a single system, the term “system” shall also be taken to include any collection of systems or sub-systems that individually or jointly execute a set, or multiple sets, of instructions to perform one or more computer functions.

As illustrated in FIG. 2, the controller 200 may include a processor 202, e.g., a central processing unit (CPU), a graphics processing unit (GPU), or both. The processor 202 may be a component in a variety of systems. For example, the processor 202 may be part of a standard computer. The processor 202 may be one or more general processors, digital signal processors, application specific integrated circuits, field programmable gate arrays, servers, networks, digital circuits, analog circuits, combinations thereof, or other now known or later developed devices for analyzing and processing data. The processor 202 may implement a software program, such as code generated manually (i.e., programmed).

The controller 200 may include a memory 204 that can communicate via a bus 218. The memory 204 may be a main memory, a static memory, or a dynamic memory. The memory 204 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 204 includes a cache or random-access memory for the processor 202. In alternative implementations, the memory 204 is separate from the processor 202, such as a cache memory of a processor, the system memory, or other memory. The memory 204 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 204 is operable to store instructions executable by the processor 202. The functions, acts or tasks illustrated in the figures or described herein may be performed by the processor 202 executing the instructions stored in the memory 204. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the controller 200 may further include a display 208, such as a liquid crystal display (LCD), an organic light emitting diode (OLED), a flat panel display, a solid-state display, a cathode ray tube (CRT), a projector, a printer or other now known or later developed display device for outputting determined information. The display 208 may act as an interface for the user to see the functioning of the processor 202, or specifically as an interface with the software stored in the memory 204 or in the drive unit 206. Additionally or alternatively, the controller 200 may include an input/output device 210 configured to allow a user to interact with any of the components of controller 200. The input/output device 210 may be a number pad, a keyboard, or a cursor control device, such as a mouse, or a joystick, touch screen display, remote control, or any other device operative to interact with the controller 200. The controller 200 may also or alternatively include drive unit 206 implemented as a disk or optical drive. The drive unit 206 may include a computer-readable medium 220 in which one or more sets of instructions 216, e.g. software, can be embedded. Further, the instructions 216 may embody one or more of the methods or logic as described herein. The instructions 216 may reside completely or partially within the memory 204 and/or within the processor 202 during execution by the controller 200. The memory 204 and the processor 202 also may include computer-readable media as discussed above.

In some systems, a computer-readable medium 220 includes instructions 216 or receives and executes instructions 216 responsive to a propagated signal so that a device connected to a network 214 can communicate voice, video, audio, images, or any other data over the network 214. Further, the instructions 216 may be transmitted or received over the network 214 via a communication port or interface 212, and/or using a bus 218. The communication port or interface 212 may be a part of the processor 202 or may be a separate component. The communication port or interface 212 may be created in software or may be a physical connection in hardware. The communication port or interface 212 may be configured to connect with a network 214, external media, the display 208, or any other components in controller 200, or combinations thereof. The connection with the network 214 may be a physical connection, such as a wired Ethernet connection or may be established wirelessly as discussed below. Likewise, the additional connections with other components of the controller 200 may be physical connections or may be established wirelessly. The network 214 may alternatively be directly connected to a bus 218.

While the computer-readable medium 220 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 220 may be non-transitory, and may be tangible. The computer-readable medium 220 can include a solid-state memory such as a memory card or other package that houses one or more non-volatile read-only memories. The computer-readable medium 220 can be a random-access memory or other volatile re-writable memory. Additionally or alternatively, the computer-readable medium 220 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 200 may be connected to a network 214. The network 214 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 214 may include wide area networks (WAN), such as the Internet, local area networks (LAN), campus area networks, metropolitan area networks, a direct connection such as through a Universal Serial Bus (USB) port, or any other networks that may allow for data communication. The network 214 may be configured to couple one computing device to another computing device to enable communication of data between the devices. The network 214 may generally be enabled to employ any form of machine-readable media for communicating information from one device to another. The network 214 may include communication methods by which information may travel between computing devices. The network 214 may be divided into sub-networks. The sub-networks may allow access to all of the other components connected thereto or the sub-networks may restrict access between the components. The network 214 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof. It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

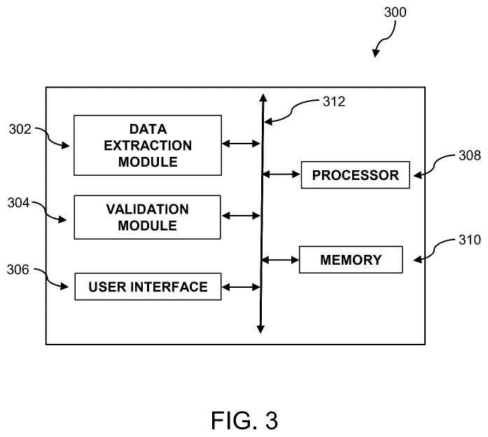

FIG. 3 illustrates a schematic diagram showing an implementation of an exemplary data extracting system, in accordance with one or more example embodiments described herein. In one or more example embodiments, the data extracting system 300 is configured to extract relevant data from document(s) associated with assets in a facility (for instance, one or more facilities 102a, 102b . . . 102n as described in FIG. 1 of the current disclosure). Generally, the facility maintains data sources such as repositories or databases to store appropriate documents associated with the assets. In this regard, the data extracting system 300 retrieves one or more documents from such data sources over a network to extract relevant data from those documents. The documents may be, but not limited to engineering documents, process flow diagrams (PFDs), piping and instrumentation diagrams (P&IDs), datasheets and/or the like. The documents described herein comprise information in various formats that is, with symbols such as lines, arrows, components, connections, and/or the like along with texts comprising alphabets and/or numbers to depict information related to various assets in the facility. To extract the data, the data extracting system 300 employs several processing and validation techniques. That is, the data extracting system 300 using a first processing technique extracts first data while second data is extracted using a second processing technique. The first processing technique may correspond to image processing techniques based on machine learning (ML) models and natural language processing (NLP). Whereas the second processing technique may correspond to optical character recognition (OCR). Also, the data extracting system 300 uses one or more validation techniques to validate the extracted data that is, for instance, the first data. Using such extracted and validated datasets, the data extracting system 300 configures that is, fills one or more data templates that can be used to model assets, analyze faults associated with assets, address alerts related to assets, and/or the like in the facility. This improves overall management of assets along with efficient usage of human and/or computing resources in the facility. Accordingly, in some example embodiments, the system 300 facilitates a practical application of data analytics technology and/or digital transformation technology to extract relevant asset data in the facility.

In some example embodiments, the data extracting system 300 is a server system (e.g., a server device) that facilitates a data analytics platform between one or more computing devices, one or more data sources, and/or one or more facilities. In some example embodiments, the data extracting system 300 is a device with one or more processors and a memory. Also, in some example embodiments, the data extracting system 300 is implementable via the cloud 106. The data extracting system 300 is implementable in one or more facilities related to one or more technologies, for example, but not limited to, enterprise technologies, connected building technologies, industrial technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, life science technologies, process plant technologies, procurement technologies, and/or one or more other technologies.

In some example embodiments, the data extracting system 300 comprises one or more components such as, a data extraction module 302, a validation module 304, and/or a user interface 306. Additionally, in one or more example embodiments, the data extracting system 300 comprises a processor 308 and/or a memory 310. In one or more example embodiments, one or more components of the data extracting system 300 may be communicatively coupled to processor 308 and/or a memory 310 via a bus 312. In certain example embodiments, one or more aspects of the data extracting system 300 (and/or other systems, apparatuses and/or processes disclosed herein) constitute executable instructions embodied within a computer-readable storage medium (e.g., the memory 310). For instance, in an example embodiment, the memory 310 stores computer executable component and/or executable instructions (e.g., program instructions). Furthermore, the processor 308 facilitates execution of the computer executable components and/or the executable instructions (e.g., the program instructions). In an example embodiment, the processor 308 is configured to execute instructions stored in the memory 310 or otherwise accessible to the processor 308.

The processor 308 is a hardware entity (e.g., physically embodied in circuitry) capable of performing operations according to one or more embodiments of the disclosure. Alternatively, in an example embodiment where the processor 308 is embodied as an executor of software instructions, the software instructions configure the processor 308 to perform one or more algorithms and/or operations described herein in response to the software instructions being executed. In an example embodiment, the processor 308 is a single core processor, a multi-core processor, multiple processors internal to the data extracting system 300, a remote processor (e.g., a processor implemented on a server), and/or a virtual machine. In certain example embodiments, the processor 308 is in communication with the memory 310, the data extraction module 302, the validation module 304, and/or the user interface 306 via the bus 312 to, for example, facilitate transmission of data between the processor 308, the memory 310, the data extraction module 302, the validation module 304, and/or the user interface 306. In some example embodiments, the processor 308 may be embodied in a number of different ways and, in certain example embodiments, includes one or more processing devices configured to perform independently. Additionally or alternatively, in one or more example embodiments, the processor 308 includes one or more processors configured in tandem via bus 312 to enable independent execution of instructions, pipelining of data, and/or multi-thread execution of instructions.

The memory 310 is non-transitory and includes, for example, one or more volatile memories and/or one or more non-volatile memories. In other words, in one or more example embodiments, the memory 310 is an electronic storage device (e.g., a computer-readable storage medium). The memory 310 is configured to store information, data, content, one or more applications, one or more instructions, or the like, to enable the data extracting system 300 to carry out various functions in accordance with one or more embodiments disclosed herein. In accordance with some example embodiments described herein, the memory 310 may correspond to an internal or external memory of the data extracting system 300. In some examples, the memory 310 may correspond to a database communicatively coupled to the data extracting system 300. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

In one or more example embodiments, the data extraction module 302 is configured to retrieve one or more documents associated with one or more assets in the facility from one or more data sources. In this regard, the data extraction module 302 retrieves documents such as one or more engineering documents, one or more process flow diagrams (PFDs), one or more piping and instrumentation diagrams (P&IDs), one or more datasheets, and/or the like from the one or more data sources. The one or more data sources may correspond to databases/repositories where the documents associated with the said assets are generally stored by the facility. Additionally, the facility also maintains the documents in the one or more data sources by regularly updating the one or more data sources to include the latest documents associated with the assets. The documents may be provided by one or more users associated with the facility. In this regard, the one or more users may correspond to operators, engineers, customers, original equipment manufacturers (OEMs), and/or other personnel associated with the facility. Also, the one or more documents comprise information related to the one or more assets in various formats that is, the one or more documents comprise symbols such as lines, arrows, components, connections, and/or the like along with texts comprising alphabets and/or numbers. Additionally, it is to be noted that the one or more documents may be in electronic format such as a portable document file (PDF) and/or any other electronic data format as well. Also, the data extraction module 302 is capable of converting at least a portion of a document into image formats such as, but not limited to Portable Network Graphics (PNG) format, Joint Photographic Experts Group (JPEG) format, and/or the like.

In one or more example embodiments, the data extraction module 302 is configured to employ one or more processing techniques to process the one or more documents. That is, the data extraction module 302 processes at least one document of the one or more documents using the said processing techniques to extract relevant data/information associated with the assets from the at least one document. In this regard, initially the data extraction module 302 processes the at least one document using a first processing technique of the one or more processing techniques. The first processing technique corresponds to one or more image processing techniques. Also, it is to be noted that the one or more image processing techniques may be based on machine learning (ML) and natural language processing techniques. The data extraction module 302 applies the first processing technique on the at least one document to analyze content (more specifically, content associated with symbolic representations) related to the assets in the at least one document. Often the at least one document of the one or more documents comprises one or more schematic illustrations of various assets, operating units, processing sections, and/or the like that are present in the facility along with one or more graphical representations. Per this aspect, the one or more schematic illustrations depict information such as interconnection of the one or more assets, one or more instrumentations that are used for process(es) in the facility, associated flow directions of one or more materials in the one or more assets, one or more control signals to control associated assets, and/or the like. The one or more schematic illustrations often comprise one or more symbolic representations to depict the required information. In this regard, the one or more symbolic representations correspond to equipment, piping, and/or instrumentation in the at least one document. The symbolic representations corresponding to equipment often comprise symbols of assets or equipment in the facility such as, but not limited to pumps, compressors, heat exchangers, mixers, filters, centrifuges, distillation columns, vessels (for example, tanks, drums, reactors, etc.,), and/or the like. While the symbolic representations corresponding to piping often comprise symbols of pipelines such as, but not limited to straight pipes, elbows, valves, reducers, expansion joints, branch connections, flanges, crosses, and/or the like that facilitate movement of one or more materials between the one or more assets along with arrows indicating flow directions. Yet the symbolic representations corresponding to instrumentation often comprise symbols of instruments such as, but not limited to flow meters, pressure gauges, temperature sensors, level sensors, control valves, transmitters, switches, analyzers, and/or the like that are used to monitor and control process parameters associated with the one or more assets and/or related processes in the facility. Also, the symbolic representations comprise one or more graphs related to the assets in the facility. While the data extraction module 302 applies the first processing technique on the at least one document with such schematic illustrations, the data extraction module 302 identifies the said one or more symbolic representations in the at least one document.

The data extraction module 302 then analyzes one or more textual representations in proximity to the one or more symbolic representations in the at least one document. In this regard, the one or more textual representations may be numerical and/or alphabetical representations in proximity to the one or more symbolic representations which is often included in the schematic illustrations. Also, the data extraction module 302 determines if the proximity of the one or more textual representations satisfies one or more first thresholds. In this regard, the one or more first thresholds are defined relative to: size of the one or more symbolic representations, a type of the one or more symbolic representations, co-ordinates of a corresponding textual representation in the at least one document, and/or a distance between at least one symbolic representation and the corresponding textual representation. Based on the determination that the proximity of the one or more textual representations satisfies the one or more first thresholds, the data extraction module 302 identifies the one or more textual representations to be one or more instrument tags that may be indicative of asset type, instrument type, signal connections, asset identifiers, process parameters, process measurements, and/or the like. This is to make sure that only relevant textual representations are identified as instrument tags from the at least one document. The one or more instrument tags are then extracted from the at least one document. This corresponds to first data (or first dataset) extracted by the data extraction module 302 from the at least one document using the first processing technique for corresponding assets.

In one or more example embodiments, the data extraction module 302 is then configured to transmit the first data to the validation module 304. In this regard, the validation module 304 validates the first data using one or more validation techniques. The one or more validation techniques may be based on machine learning and/or artificial intelligence algorithms. Firstly, the validation module 304 validates the first data using a first validation technique of the one or more validation techniques. As a part of the first validation technique, the validation module 304 compares at least one instrument tag of the one or more instrument tags with one or more tags provided by one or more users. The one or more users here may be, but not limited to OEMs, customers, and/or the like. Then, based on the comparison, the validation module 304 determines a first validation score for the at least one instrument tag of the one or more instrument tags. The first validation score indicates an accuracy level associated with the at least one instrument tag that is extracted from the at least one document. Often the content in the documents is subjected to variations as the documents are provided by diverse users. Said alternatively, each of the users may have their own standards and/or conventions in accordance with which the content is provided in the corresponding documents. For instance, a representation of a pump may be presented in a certain way by a first OEM while the same pump may be represented in another way by a second OEM or a customer. Despite such variations, the first validation technique makes sure to compare extracted instrument tags with user provided tags so that the extracted data is not misinterpreted by the data extraction module 302. Also, it is to be noted that the validation module 304 learns and improves accuracy of validation over a period of time. Secondly, the validation module 304 validates the first data using a second validation technique of the one or more validation techniques. In this regard, the validation module 304 verifies the at least one instrument tag using one or more rules defined by subject matter experts and/or technical experts associated with the facility. The one or more rules in the validation module 304 may be updated regularly as well. Additionally, the validation module 304 verifies the at least one instrument tag using co-ordinates of corresponding textual representation in the at least one document, one or more material flow directions, and/or one or more process variables (such as controlled variables, manipulated variables, and/or the like) as well. Then, based on the comparison, the validation module 304 determines a second validation score for the at least one instrument tag of the one or more instrument tags. The second validation score also indicates an accuracy level associated with the at least one instrument tag that is extracted from the at least one document. Further, the validation module 304 determines a validation score for the at least one instrument tag based on the first validation score and the second validation score. The validation score indicates a final score or a weightage for the at least one instrument tag. Usage of the first validation score and/or the second validation score enhances indication of accuracy with which the at least one instrument tag is extracted from the at least one document.

In one or more example embodiments, the data extraction module 302 then processes the at least one document of the one or more documents using a second processing technique of the one or more processing techniques. In this regard, the second processing technique corresponds to optical character recognition (OCR). The data extraction module 302 applies the second processing technique on the at least one document to analyze content (more specifically, content associated with predefined shapes) related to the assets in the at least one document. At times, the at least one document comprises one or more predefined shapes such as one or more tabular representations in addition to the one or more schematic illustrations. In this regard, the one or more tabular representations comprise data such as, but not limited to asset specifications, operating points, measurements associated with the assets, maintenance or general notes associated with the assets, and/or the like. While the data extraction module 302 applies the second processing technique on the at least one document, the data extraction module 302 identifies the said tabular representations corresponding to the predefined shapes in the at least one document.

The data extraction module 302 then analyzes one or more textual representations associated with the one or more predefined shapes in the at least one document using the second processing technique. In this regard, the one or more textual representations may be numerical and/or alphabetical representations in the one or more tabular representations. Also, the data extraction module 302 determines if the one or more textual representations associated with the one or more predefined shapes satisfies one or more second thresholds. In this regard, the one or more second thresholds are defined relative to: size of the one or more predefined shapes, a type of the one or more predefined shapes, and co-ordinates of a corresponding textual representation in the at least one document. Based on a determination that the proximity of the one or more textual representations satisfies the one or more second thresholds, the data extraction module 302 identifies the one or more textual representations to be second data (or second dataset) if the one or more textual representations satisfies one or more second thresholds. Accordingly, the data extraction module 302 extracts the second data from the at least one document. Additionally, in one or more example embodiments, the data extraction module 302 derives one or more units of measurements and one or more operating limits associated with the corresponding assets based at least on the second data. It is to be noted that the first processing technique and the second processing technique may be applied in any order by the data extraction module 302 as well.

Then, in one or more example embodiments, the data extraction module 302 consolidates the validated first data and the extracted second data. Using such consolidated data, the data extraction module 302 configures one or more data templates. That is, the data extraction module 302 fills one or more fields of corresponding data templates using consolidation of the validated first data and the extracted second data. The one or more fields of the data templates generally correspond to instrument tags, description of instrument tags, associated assets, operational limits, units of measurement, and/or the like. In one or more example embodiments, the one or more data templates for corresponding assets are also rendered on the user interface 306 (such as a display of a computing device) upon configuration of the one or more data templates. Per this aspect, the one or more data templates can be reviewed by appropriate personnel in the facility. Also, this facilitates the appropriate personnel to interact with the one or more data templates. It is to be noted that the configured data templates are then used by the data extracting system 300 to automatically generate models and/or digital twins for corresponding assets in the facility. Additionally, the said data templates are also used by the data extracting system 300 to diagnose and identify root causes of faults associated with the assets as the consolidated data provides upstream and/or downstream relationships between the assets along with material flow directions. This facilitates identification of exact location of fault along with affected assets so that appropriate actions can be taken. Also, the said data templates automate analysis and classification of alerts by the data extracting system 300 to ensure proper addressing of alerts. In this regard, the data extracting system 300 determines if the alert(s) are true positive(s) or false positive(s). With this, accuracy of data extraction from various documents is enhanced so that assets can be modelled as appropriate with minimal efforts, time, and/or resources along with timely addressal of faults and/or alerts using corrective actions. This improves overall management of assets along with efficient usage of human and/or computing resources in the facility.

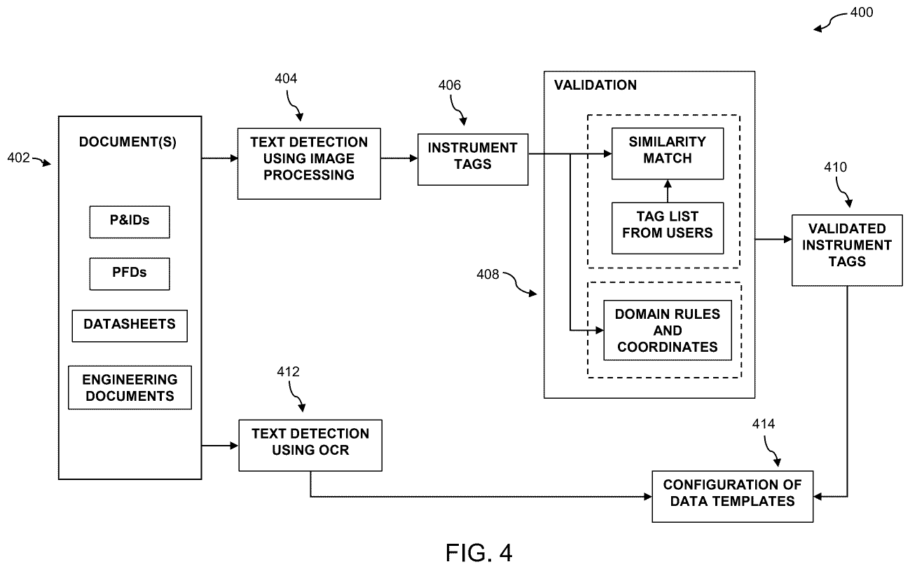

FIG. 4 illustrates a schematic diagram showing an exemplary block diagram associated with one or more operations of exemplary data extracting system, in accordance with one or more example embodiments described herein. The block diagram 400 illustrates flow of various operations performed by the data extracting system 300 as described in FIG. 3 of the current disclosure. The document(s) block 402 often include one or more of: engineering documents, process flow diagrams (PFDs), piping and instrumentation diagrams (P&IDs), datasheets, and/or the like related to the one or more assets in the facility. The document(s) 402 comprise information depicted using symbols such as lines, arrows, components, connections, and/or the like along with texts comprising alphabets and/or numbers. In this regard, the document(s) 402 comprise one or more of: schematic illustrations, graphical representations, tabular representations, textual representations, numerical representations, symbolic representations, and/or the like to depict the information associated with the one or more assets. The data extraction module 302 processes appropriate document(s) 402 to extract relevant data associated with each of the assets in the facility. In some example embodiments, information associated with an asset may be present in a single document. Whereas in some other example embodiments, information associated with an asset may be present in multiple documents. For example, all information related to a pump may be present in a single PFD. In another example, few schematic illustrations associated with a turbine may be present in a P&ID while asset specifications may be present in a datasheet different from the P&ID. Irrespective of whether the information is present in a single document or multiple documents, the data extraction module 302 makes sure to process and corelate all required documents to extract data associated with the asset.

At block 404, the data extraction module 302 processes at least one document of the document(s) 402 using image processing technique(s). Also, it is to be noted that the data extraction module 302 may pre-process the at least one document, if required. For example, if the at least one document is a portable document file (PDF), then the data extraction module 302 may pre-process one or more portions of the at least one document to Portable Network Graphics (PNG) format, Joint Photographic Experts Group (JPEG) format, and/or the like so as to be compatible for applying the image processing technique(s). The image processing technique(s) described herein are generally based on machine learning (ML) and natural language processing models. It is to be noted that the models may be trained rigorously using appropriate datasets. Using the image processing technique(s), the data extraction module 302 identifies text tied to/in proximity to symbolic representations as described in FIG. 3 of the current disclosure. At block 406, the data extraction module 302 classifies only certain text to be instrument tags using a first threshold. The instrument tags described herein may be indicative of asset type, instrument type, signal connections, asset identifiers, process parameters, process measurements, and/or the like. To be more accurate, the instrument tags are then validated at block 408 by the validation module 304 as described in FIG. 3 of the current disclosure. In this regard, the validation at block 408 comprises validation based on similarity match and/or domain rules along with co-ordinates. In similarity match, the instrument tags are compared with user provided tags. Based on the comparison, each of the instrument tags is provided with a corresponding validation score. Whereas the validation based on the domain rules along with co-ordinates comprises usage of rules defined by subject matter/technical experts along with co-ordinates of text in the at least one document. Based on the verification of each of the instrument tags with such rules and co-ordinates, each of the instrument tags is provided with another corresponding validation score. It is to be noted that the validation module 304 selectively chooses validation based on similarity match and/or domain rules along with co-ordinates. Said alternatively, the validation module 304 may use validation based on similarity match in some instances while validation using domain rules along with co-ordinates in some other instances. Also, the validation module 304 may use both similarity match and domain rules along with co-ordinates yet in some other instances. Further, at block 410 the validation module 304 then provides validated instrument tags. The validated instrument tags are also then transmitted to the data extraction module 302 as well.

The data extraction module 302 processes the at least one document using optical character recognition (OCR) at block 412. Using OCR, the data extraction module 302 identifies text tied to/in proximity to predefined shapes as described in FIG. 3 of the current disclosure. In this regard, the data extraction module 302 extracts data such as asset specifications, operating points, measurements associated with the assets, maintenance or general notes associated with the assets, and/or the like based on application of OCR at block 412. Then at block 414, the data extraction module 302 consolidates the validated instrument tags and the data extracted using OCR to configure one or more data templates. The one or more data templates are then used for modeling digital twins of assets, fault/alarm verification for assets, and/or the like in the facility.

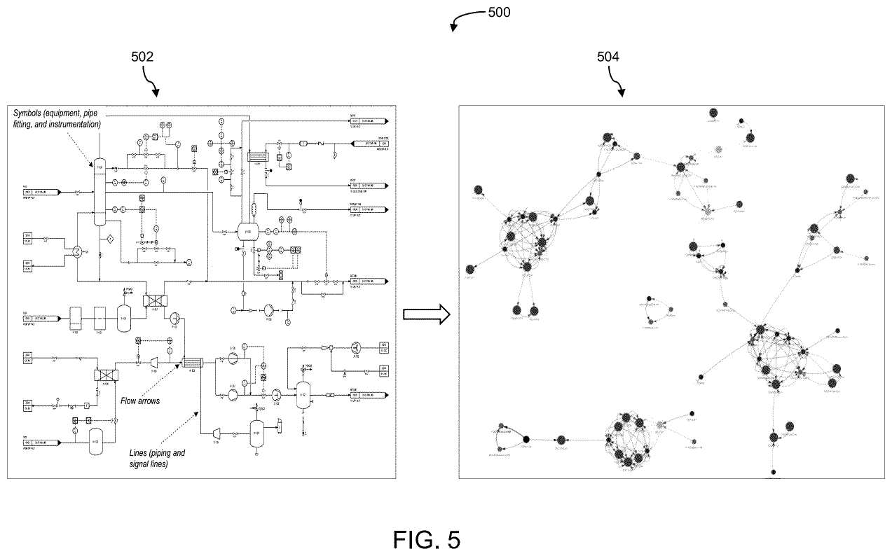

FIG. 5 illustrates a schematic diagram showing an exemplary graphical representation of instrument tags, in accordance with one or more example embodiments described herein. As described in FIG. 3 of the current disclosure, the data extraction module 302 extracts first data indicative of one or more instrument tags from at least one document. That is, the data extraction module 302 applies first processing technique on the at least one document to extract the first data. In accordance with one or more example embodiments described herein, the data extraction module 302 applies the first processing technique on, for instance, document 502. The example document 502 described herein is a piping and instrumentation diagram (P&ID) illustrating piping between various assets/equipment in the facility along with instruments involved for measurements and controlling the assets. The exemplary document 502 comprises various symbolic representations such as symbols of assets or equipment in the facility, symbols of piping between the said assets indicating material flow directions and connection between the said assets, and symbols of various instruments. It is to be noted that there are textual representations (numerical and/or alphabetical) in and around such symbols in the document 502. Upon application of the first processing technique, the data extraction module 302 extracts such textual representations and validates them to be one or more instrument tags. Also, the data extraction module 302 generates a graphical model such as an ontology model 504 to indicate relationship between the validated instrument tags. The relationship between the tags in the ontology model 504 indicates connection between various assets in the facility, upstream and/or downstream relationships between various assets in the facility, hierarchical arrangement of assets in the facility, and/or the like. Also, the ontology model 504 described herein is configured to update at regular intervals as and when new instrument tags are extracted by the data extraction module 302.

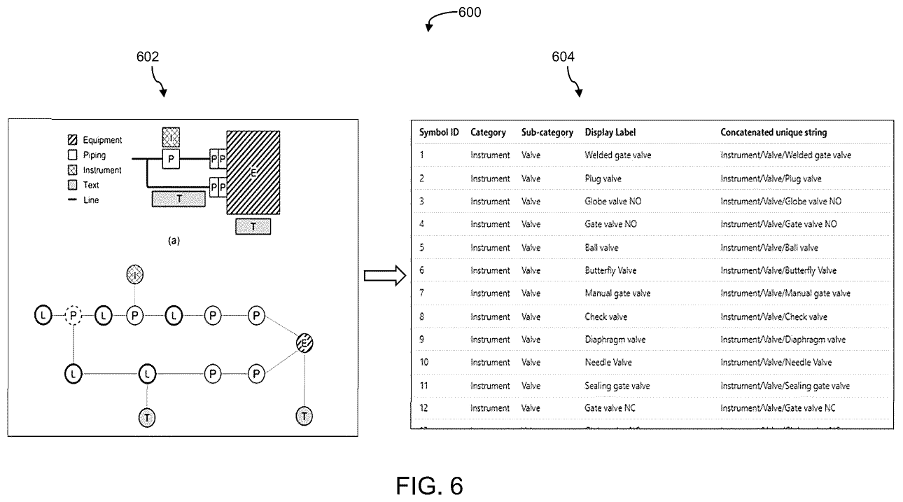

FIG. 6 illustrates a schematic diagram showing an exemplary hierarchical representation of extracted text, in accordance with one or more example embodiments described herein. The data extraction module 302 processes the at least one exemplary document 502 to generate the ontology model 504 as described in FIG. 5 of the current disclosure. During processing of the document 502, the data extraction module 302 classifies various representations in the document 502 as equipment, piping, instrument, text, line, and/or the like as shown in illustration 602 of the schematic diagram 600. Based on such a classification, the data extraction module 302 appropriately identifies and derives a differentiation between symbolic representations and textual representations. This also facilitates identification of corresponding textual representations that are in proximity to/tied to corresponding symbolic representations so that the textual representations are associated with right symbolic representations. Also, the data extraction module 302 generates a graph with one or more nodes and one or more links as shown in the illustration 602. The one or more nodes and the one or more links depict connection between the various assets in the facility. Also, the one or more nodes and the one or more links associate textual representations with corresponding symbolic representations as well. Based on the graph as in the illustration 602, the data extraction module 302 then derives hierarchical representation of extracted text 604. That is, the data extraction module 302 determines a category/type of asset, a sub-category/sub-type of asset, a specification of asset, and/or the like for each asset. Each of the hierarchical representation of extracted text 604 may correspond to a unique textual string for each asset in the facility. This may be based on connection between the various assets, textual representations associated with corresponding symbolic representations, and/or corresponding symbolic representations as well. For example, for a butterfly valve (not shown) in the illustration 602, the data extraction module 302 categorizes the butterfly valve under instrument category and valve sub-category. That is, the data extraction module 302 may use textual representation(s) associated with the butterfly valve along with a symbolic representation of the butterfly valve to determine category, sub-category, and specification for the said butterfly valve. The hierarchical representation of extracted text 604 described herein may be then validated and used to derive the ontology model 504 that is described in FIG. 5 of the current disclosure.

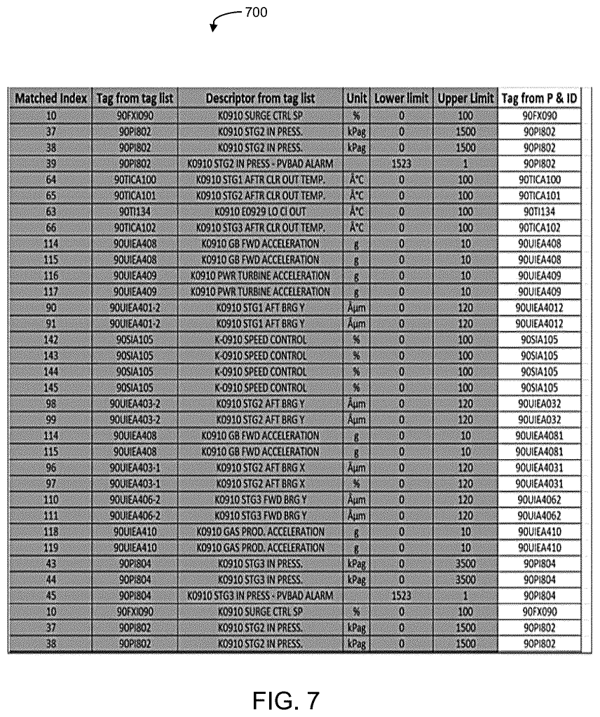

FIG. 7 illustrates a schematic diagram showing an exemplary representation of a data template, in accordance with one or more example embodiments described herein. The exemplary data template 700 described herein comprises one or more fields. The one or more fields correspond to instrument tag, user provided tag, descriptor of user provided tag, asset type, unit of measurement, operating limits, and/or the like. The one or more fields are filled using validated first data and extracted second data by the data extraction module 302 as described in FIG. 3 of the current disclosure. As it may be understood, the one or more fields in the data template 700 are exemplary only and it may comprise one or more additional fields as well. Such configured data template 700 is then used for modeling digital twins of assets, fault/alarm verification for assets, and/or the like in the facility.

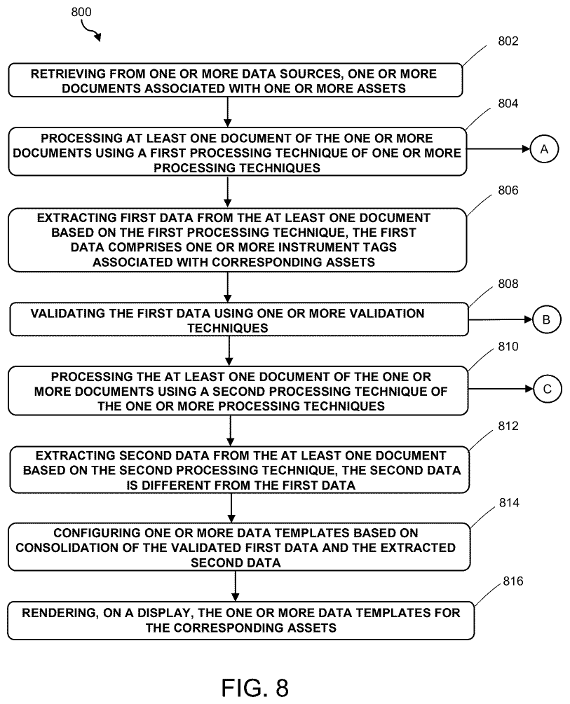

FIG. 8 illustrates a flowchart showing a method described in accordance with one or more example embodiments described herein. In this regard, FIG. 8 illustrates operations that may be performed by the data extracting system 300. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800. At step 802 of the exemplary flowchart 800, the data extracting system 300 comprises means such as, the data extraction module 302 to retrieve one or more documents associated with one or more assets from one or more data sources. In this regard, the data extraction module 302 retrieves documents such as one or more engineering documents, one or more process flow diagrams (PFDs), one or more piping and instrumentation diagrams (P&IDs), one or more datasheets, and/or the like from the one or more data sources. At step 804 of the exemplary flowchart 800, the data extracting system 300 comprises means such as, the data extraction module 302 to process at least one document of the one or more documents using a first processing technique of one or more processing techniques. At step 806 of the exemplary flowchart 800, the data extracting system 300 comprises means such as, the data extraction module 302 to extract first data from the at least one document based on the first processing technique. In this regard, the first data comprises one or more instrument tags associated with corresponding assets. At step 808 of the exemplary flowchart 800, the data extracting system 300 comprises means such as, the validation module 304 to validate the first data using one or more validation techniques. At step 810 of the exemplary flowchart 800, the data extracting system 300 comprises means such as, the data extraction module 302 to process the at least one document of the one or more documents using a second processing technique of the one or more processing techniques. At step 812 of the exemplary flowchart 800, the data extracting system 300 comprises means such as, the data extraction module 302 to extract second data from the at least one document based on the second processing technique such that the second data is different from the first data. Additionally, the data extraction module 302 derives one or more units of measurements and one or more operating limits associated with the corresponding assets based at least on the second data. At step 814 of the exemplary flowchart 800, the data extracting system 300 comprises means such as, the data extraction module 302 to configure one or more data templates based on consolidation of the validated first data and the extracted second data. At step 816 of the exemplary flowchart 800, the data extracting system 300 comprises means such as, the user interface 306 to render the one or more data templates for the corresponding assets.

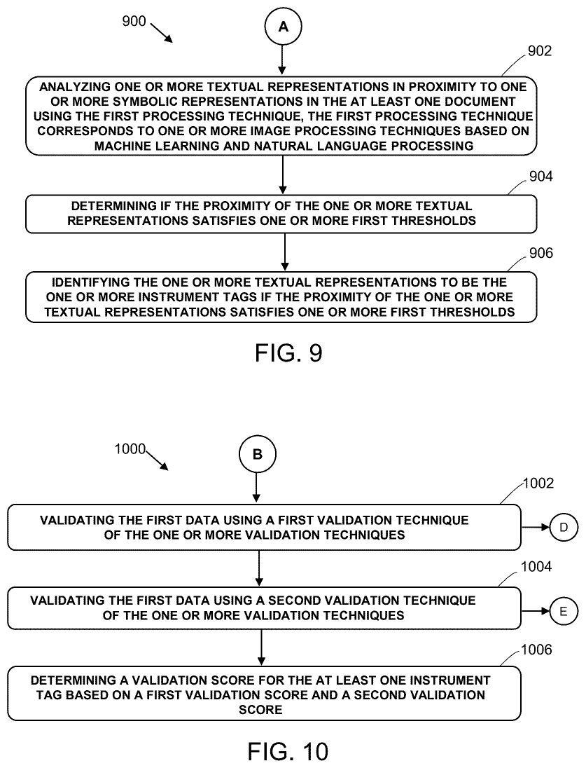

FIG. 9 illustrates a flowchart showing a method described in accordance with one or more example embodiments described herein. In this regard, FIG. 9 illustrates operations that may be performed by the data extracting system 300. In some embodiments, the example method 900 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 900. At step 902 of the exemplary flowchart 900, the data extracting system 300 comprises means such as, the data extraction module 302 to analyze one or more textual representations in proximity to one or more symbolic representations in the at least one document using the first processing technique. In this regard, the first processing technique corresponds to one or more image processing techniques based on machine learning and natural language processing. At step 904 of the exemplary flowchart 900, the data extracting system 300 comprises means such as, the data extraction module 302 to determine if the proximity of the one or more textual representations satisfies one or more first thresholds. At step 906 of the exemplary flowchart 900, the data extracting system 300 comprises means such as, the data extraction module 302 to identify the one or more textual representations to be the one or more instrument tags if the proximity of the one or more textual representations satisfies one or more first thresholds.

FIG. 10 illustrates a flowchart showing a method described in accordance with one or more example embodiments described herein. In this regard, FIG. 10 illustrates operations that may be performed by the data extracting system 300. In some embodiments, the example method 1000 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1000. At step 1002 of the exemplary flowchart 1000, the data extracting system 300 comprises means such as, the validation module 304 to validate the first data using a first validation technique of the one or more validation techniques. At step 1004 of the exemplary flowchart 1000, the data extracting system 300 comprises means such as, the validation module 304 to validate the first data using a second validation technique of the one or more validation techniques. At step 1006 of the exemplary flowchart 1000, the data extracting system 300 comprises means such as, the validation module 304 to determine a validation score for the at least one instrument tag based on a first validation score and a second validation score.

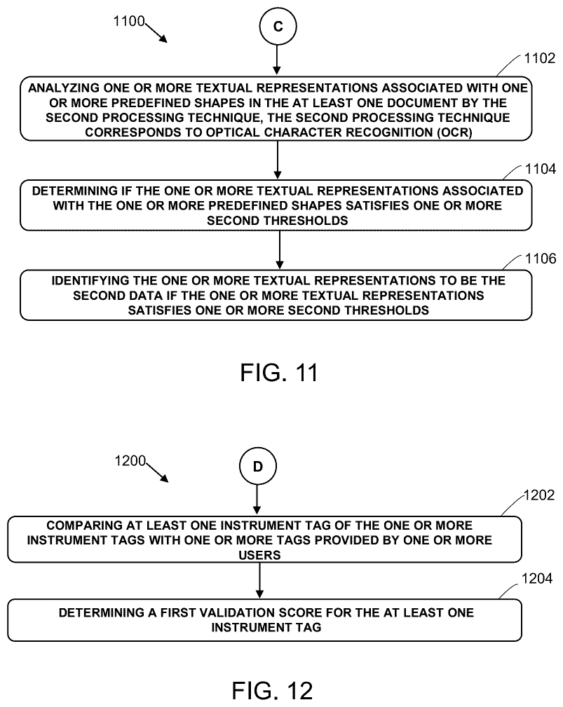

FIG. 11 illustrates a flowchart showing a method described in accordance with one or more example embodiments described herein. In this regard, FIG. 11 illustrates operations that may be performed by the data extracting system 300. In some embodiments, the example method 1100 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1100. At step 1102 of the exemplary flowchart 1100, the data extracting system 300 comprises means such as, the data extraction module 302 to analyze one or more textual representations associated with one or more predefined shapes in the at least one document by the second processing technique. In this regard, the second processing technique corresponds to optical character recognition (OCR). At step 1104 of the exemplary flowchart 1100, the data extracting system 300 comprises means such as, the data extraction module 302 to determine if the one or more textual representations associated with the one or more predefined shapes satisfies one or more second thresholds. At step 1106 of the exemplary flowchart 1100, the data extracting system 300 comprises means such as, the data extraction module 302 to identify the one or more textual representations to be the second data if the one or more textual representations satisfies one or more second thresholds.

FIG. 12 illustrates a flowchart showing a method described in accordance with one or more example embodiments described herein. In this regard, FIG. 12 illustrates operations that may be performed by the data extracting system 300. In some embodiments, the example method 1200 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1200. At step 1202 of the exemplary flowchart 1200, the data extracting system 300 comprises means such as, the validation module 304 to compare at least one instrument tag of the one or more instrument tags with one or more tags provided by one or more users. At step 1204 of the exemplary flowchart 1200, the data extracting system 300 comprises means such as, the validation module 304 to determine a first validation score for the at least one instrument tag.

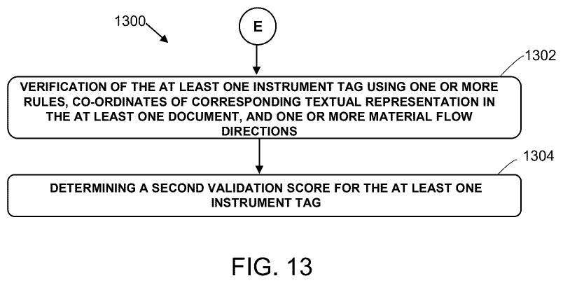

FIG. 13 illustrates a flowchart showing a method described in accordance with one or more example embodiments described herein. In this regard, FIG. 13 illustrates operations that may be performed by the data extracting system 300. In some embodiments, the example method 1300 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1300. At step 1302 of the exemplary flowchart 1300, the data extracting system 300 comprises means such as, the validation module 304 to verify the at least one instrument tag using one or more rules, co-ordinates of corresponding textual representation in the at least one document, and one or more material flow directions. At step 1304 of the exemplary flowchart 1300, the data extracting system 300 comprises means such as, the validation module 304 to determine a second validation score for the at least one instrument tag.

The foregoing embodiments are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray Disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

1. A method for extracting data from one or more documents associated with one or more assets in a facility, the method comprising:
retrieving from one or more data sources, the one or more documents associated with the one or more assets;
processing at least one document of the one or more documents using a first processing technique of one or more processing techniques;
extracting first data from the at least one document based on the first processing technique, wherein the first data comprises one or more instrument tags associated with corresponding assets;
validating the first data using one or more validation techniques;
processing the at least one document of the one or more documents using a second processing technique of the one or more processing techniques;
extracting second data from the at least one document based on the second processing technique, wherein the second data is different from the first data;
configuring one or more data templates based on consolidation of the validated first data and the extracted second data; and
rendering, on a display, the one or more data templates for the corresponding assets.

2. The method of claim 1, wherein retrieving the one or more documents from the one or more data sources comprises:
retrieving at least one of: one or more engineering documents, one or more process flow diagrams (PFDs), one or more piping and instrumentation diagrams (P&IDs), and one or more datasheets from the one or more data sources.

3. The method of claim 1, wherein processing the at least one document using the first processing technique comprises:
analyzing one or more textual representations in proximity to one or more symbolic representations in the at least one document using the first processing technique, wherein the first processing technique corresponds to one or more image processing techniques based on machine learning and natural language processing;
determining if the proximity of the one or more textual representations satisfies one or more first thresholds, wherein the one or more first thresholds are defined relative to size of the one or more symbolic representations, a type of the one or more symbolic representations, co-ordinates of a corresponding textual representation in the at least one document, and a distance between at least one symbolic representation and the corresponding textual representation; and
identifying the one or more textual representations to be the one or more instrument tags if the proximity of the one or more textual representations satisfies one or more first thresholds.

4. The method of claim 1, wherein validating the first data comprises:
validating the first data using a first validation technique of the one or more validation techniques, wherein the first validation technique comprises:
comparing at least one instrument tag of the one or more instrument tags with one or more tags provided by one or more users; and
determining a first validation score for the at least one instrument tag;
validating the first data using a second validation technique of the one or more validation techniques, wherein the second validation technique comprises:
verification of the at least one instrument tag using one or more rules, co-ordinates of corresponding textual representation in the at least one document, and one or more material flow directions; and
determining a second validation score for the at least one instrument tag; and
determining a validation score for the at least one instrument tag based on the first validation score and the second validation score.

5. The method of claim 1, wherein processing the at least one document using the second processing technique comprises:
analyzing one or more textual representations associated with one or more predefined shapes in the at least one document by the second processing technique, wherein the second processing technique corresponds to optical character recognition (OCR);
determining if the one or more textual representations associated with the one or more predefined shapes satisfies one or more second thresholds, wherein the one or more second thresholds are defined relative to size of the one or more predefined shapes, a type of the one or more predefined shapes, and co-ordinates of a corresponding textual representation in the at least one document; and
identifying the one or more textual representations to be the second data if the one or more textual representations satisfies one or more second thresholds.

6. The method of claim 1, wherein configuring the one or more data templates comprises filling one or more fields of corresponding data templates using consolidation of the validated first data and the extracted second data.

7. The method of claim 1, further comprising: deriving one or more units of measurements and one or more operating limits associated with the corresponding assets based at least on the second data.

8. A system for extracting data from one or more documents associated with one or more assets in a facility, the system comprising:
a processor;
a memory communicatively coupled to the processor, wherein the memory comprises one or more instructions which when executed by the processor, cause the processor to:
retrieve from one or more data sources, the one or more documents associated with the one or more assets;
process at least one document of the one or more documents using a first processing technique of one or more processing techniques;
extract first data from the at least one document based on the first processing technique, wherein the first data comprises one or more instrument tags associated with corresponding assets;
validate the first data using one or more validation techniques;
process the at least one document of the one or more documents using a second processing technique of the one or more processing techniques;
extract second data from the at least one document based on the second processing technique, wherein the second data is different from the first data;
configure one or more data templates based on consolidation of the validated first data and the extracted second data; and
render, on a display, the one or more data templates for the corresponding assets.

9. The system of claim 8, wherein the processor is further configured to:
retrieve at least one of: one or more engineering documents, one or more process flow diagrams (PFDs), one or more piping and instrumentation diagrams (P&IDs), and one or more datasheets from the one or more data sources.

10. The system of claim 8, wherein the processor is further configured to:
analyze one or more textual representations in proximity to one or more symbolic representations in the at least one document using the first processing technique, wherein the first processing technique corresponds to one or more image processing techniques based on machine learning and natural language processing;
determine if the proximity of the one or more textual representations satisfies one or more first thresholds, wherein the one or more first thresholds are defined relative to size of the one or more symbolic representations, a type of the one or more symbolic representations, co-ordinates of a corresponding textual representation in the at least one document, and a distance between at least one symbolic representation and the corresponding textual representation; and
identify the one or more textual representations to be the one or more instrument tags if the proximity of the one or more textual representations satisfies one or more first thresholds.

11. The system of claim 8, wherein the processor is further configured to:
validate the first data using a first validation technique of the one or more validation techniques, wherein the first validation technique comprises:
comparing at least one instrument tag of the one or more instrument tags with one or more tags provided by one or more users; and
determining a first validation score for the at least one instrument tag;
validate the first data using a second validation technique of the one or more validation techniques, wherein the second validation technique comprises:
verification of the at least one instrument tag using one or more rules, co-ordinates of corresponding textual representation in the at least one document, and one or more material flow directions; and
determining a second validation score for the at least one instrument tag; and
determine a validation score for the at least one instrument tag based on the first validation score and the second validation score.

12. The system of claim 8, wherein the processor is further configured to:
analyze one or more textual representations associated with one or more predefined shapes in the at least one document by the second processing technique, wherein the second processing technique corresponds to optical character recognition (OCR);
determine if the one or more textual representations associated with the one or more predefined shapes satisfies one or more second thresholds, wherein the one or more second thresholds are defined relative to size of the one or more predefined shapes, a type of the one or more predefined shapes, and co-ordinates of a corresponding textual representation in the at least one document; and
identify the one or more textual representations to be the second data if the one or more textual representations satisfies one or more second thresholds.

13. The system of claim 8, wherein the processor is further configured to fill one or more fields of corresponding data templates using consolidation of the validated first data and the extracted second data.

14. The system of claim 8, wherein the processor is further configured to derive one or more units of measurements and one or more operating limits associated with the corresponding assets based at least on the second data.

15. A non-transitory, computer-readable storage medium having stored thereon executable instructions that, when executed by one or more processors, cause the one or more processors to:
retrieve from one or more data sources, the one or more documents associated with the one or more assets;
process at least one document of the one or more documents using a first processing technique of one or more processing techniques;
extract first data from the at least one document based on the first processing technique, wherein the first data comprises one or more instrument tags associated with corresponding assets;
validate the first data using one or more validation techniques;
process the at least one document of the one or more documents using a second processing technique of the one or more processing techniques;
extract second data from the at least one document based on the second processing technique, wherein the second data is different from the first data;
configure one or more data templates based on consolidation of the validated first data and the extracted second data; and
render, on a display, the one or more data templates for the corresponding assets.

16. The non-transitory, computer-readable storage medium of claim 15, wherein the one or more processors is further configured to:
retrieve at least one of: one or more engineering documents, one or more process flow diagrams (PFDs), one or more piping and instrumentation diagrams (P&IDs), and one or more datasheets from the one or more data sources.

17. The non-transitory, computer-readable storage medium of claim 15, wherein the one or more processors is further configured to:
analyze one or more textual representations in proximity to one or more symbolic representations in the at least one document using the first processing technique, wherein the first processing technique corresponds to one or more image processing techniques based on machine learning and natural language processing;
determine if the proximity of the one or more textual representations satisfies one or more first thresholds, wherein the one or more first thresholds are defined relative to size of the one or more symbolic representations, a type of the one or more symbolic representations, co-ordinates of a corresponding textual representation in the at least one document, and a distance between at least one symbolic representation and the corresponding textual representation; and
identify the one or more textual representations to be the one or more instrument tags if the proximity of the one or more textual representations satisfies one or more first thresholds.

18. The non-transitory, computer-readable storage medium of claim 15, wherein the one or more processors is further configured to:
validate the first data using a first validation technique of the one or more validation techniques, wherein the first validation technique comprises:
comparing at least one instrument tag of the one or more instrument tags with one or more tags provided by one or more users; and
determining a first validation score for the at least one instrument tag;
validate the first data using a second validation technique of the one or more validation techniques, wherein the second validation technique comprises:
verification of the at least one instrument tag using one or more rules, co-ordinates of corresponding textual representation in the at least one document, and one or more material flow directions; and
determining a second validation score for the at least one instrument tag; and
determine a validation score for the at least one instrument tag based on the first validation score and the second validation score.

19. The non-transitory, computer-readable storage medium of claim 15, wherein the one or more processors is further configured to:
analyze one or more textual representations associated with one or more predefined shapes in the at least one document by the second processing technique, wherein the second processing technique corresponds to optical character recognition (OCR);
determine if the one or more textual representations associated with the one or more predefined shapes satisfies one or more second thresholds, wherein the one or more second thresholds are defined relative to size of the one or more predefined shapes, a type of the one or more predefined shapes, and co-ordinates of a corresponding textual representation in the at least one document; and
identify the one or more textual representations to be the second data if the one or more textual representations satisfies one or more second thresholds.

20. The non-transitory, computer-readable storage medium of claim 15, wherein the one or more processors is further configured to derive one or more units of measurements and one or more operating limits associated with the corresponding assets based at least on the second data.
